(19) United States
(12) Patent Application Publication
(10) Pub. No.: US 2011/0189387 A1
(43) Pub. Date: Aug. 4, 2011

(54) EXACT MATCH NO SAND WOOD FLOOR REPAIR KIT

(75) Inventors: Donald F. BURCH, Plano, IL (US); Richard L. SEITZINGER, Chicago, IL (US)

(73) Assignee: TOUCH-UP PRODUCTS LTD., Cary, IL (US)

(21) Appl. No.: 13/087,869

(22) Filed: Apr. 15, 2011

(51) Int. Cl. B05D 3/12; B05C 17/10

(52) U.S. Cl. 427/140; 118/56

(57) ABSTRACT

A repair kit for repairing wood floors without sanding includes a two-part epoxy putty with an epoxy resin and filler, while the second part has a hardener. The filler may be one or more of an alkali silicate, alkaline earth silicate, silica, and borosilicate. The kit further includes a flexible card with a flat or nearly-flat edge, a palette of color cards, and an activator solution. Each color card has a pigmented lacquer deposited on color card and the activator solution is used to dissolve the lacquer off of the surface of the card.

### BACKGROUND OF THE INVENTION

Wood or wood laminate floors have become very popular in private residences in recent years because they provide a number of distinct advantages over the other common alternative, carpeting. First, wood floors are available in a wide variety of colors and shades that are often selected to suit the taste of the homeowner. Second, wood and wood laminate floors are easy to clean and do not trap dirt and debris like carpet does. Spills and dirt can simply be wiped up with a dry or wet cloth without the need for harsh chemicals or steam cleaning Third, these floors are usually very durable, often lasting twenty or more years with proper care.

Unfortunately, the upper surface of the wood floor inevitably becomes scratched due to normal wear. Additionally, heavy or sharp objects may be dropped onto or moved across the surface, leaving a dent, scratch, or gouge. In the process of making such an indentation, one or more raised edges surrounding it are typically also created. These imperfections collect dirt and debris from the surrounding area and usually become discolored.

Traditionally and when a wood floor has accumulated enough scratches, dents and gouges, the entirety of the floor is sanded and refinished. It is not usually possible to sand only a small portion of the floor if an aesthetically acceptable result is desired. This step is of course labor-intensive, dusty and time-consuming. Since wood and wood laminate floors are usually expensive to purchase and install, homeowners need a way to extend the life of their floors by repairing the surface in a way that does not involve sanding and refinishing the whole floor, that is easy to use, that matches the color and texture of the floor, and that provides the necessary flexibility and durability as a wear surface.

### SUMMARY OF THE INVENTION

According to one aspect of the invention, a method of repairing a scratch or gouge in a surface of a solid wood or wood laminate floor begins with the steps of removing debris from the scratch or gouge and pressing down any raised edges that border the scratch to a level at or below the surface of the wood or laminate. After the scratch has been cleaned and any raised edges around it have been depressed (not sanded), a two-part epoxy putty is mixed to create a putty mass and rolled into a ball having a volume which exceeds that of the scratch or gouge. The first part of the putty includes an epoxy resin and a filler that is selected from the group consisting of alkali silicates, alkaline earth silicates, silicas, borosilicates, and mixtures of the foregoing. The second part includes a hardener.

The method further includes the steps of pressing a portion of the putty mass into the scratch or gouge, contacting a straight edge of a flexible plastic card to the surface of the floor at a point near a first end of the gouge or scratch, angling a downward surface of the card toward the scratch or gouge at an angle of between forty and fifty degrees relative to the surface, and drawing the angled card along the scratch or gouge from the first end to a second end of the scratch. The user maintains downward pressure on the card to remove excess putty mass and to further press the putty into the gouge or scratch. After this first stroke, the user removes any excess putty which has accumulated on the card.

The user preferably then reverses direction by contacting the edge of the card to a location on the surface of the floor near the second end of the scratch or gouge, angling the downward surface of the card toward the scratch or gouge at an angle of between forty and fifty degrees relative to the surface of the floor, and drawing the angled card along the gouge or scratch from the second end to the first end, all the while maintaining downward pressure on the straight edge to fill in any remaining voids in the scratch or gouge.

The user then smoothes the installed putty with a wetted finger and allows the result to cure. Importantly, the user does not need to sand the filled-in scratch or the surrounding area of the floor to achieve a level and smooth surface.

Thereafter, the user selects a color card from a plurality of color cards that matches the color of the surface of the floor. An activator solution is applied to a surface of the color card as a vehicle, dissolving a pigmented lacquer that forms the card's surface. The dissolved lacquer and activator solution is then applied, preferably with a natural-bristle pointed brush, to an upper surface of the putty mass within the scratch or gouge. More preferably, the brush is a #4 red sable brush. The result is a glossy surface which can be made to be visually indistinguishable from a distance of three to four feet. Optionally the user may apply a topcoat of polyurethane to increase durability.

In another embodiment, a kit for repairing a gouge or scratch in a surface of solid wood or wood laminate surface comprises a two-part epoxy putty, a flexible plastic card having a substantially straight and flat edge, a plurality of color cards each having a lacquer pigment deposited thereon, and an activator solution as a vehicle for the lacquer. The first part of the putty includes an epoxy resin and a filler that is selected from the group consisting of alkali silicates, alkaline earth silicates, silicas, borosilicates, and mixtures of the foregoing. The second part has a hardener. Preferably, the flexible card has a small coefficient of friction with respect to the putty, and a hardness that is less than that of the wood surface sought to be repaired. Certain hard plastics, such as polyvinyl chloride acetate, combine the necessary properties of elasticity, slipperiness with respect to the putty, and softness with respect to the wood flooring being repaired. The kit also preferably includes a brush for applying the dissolved lacquer to the surface of the cured putty, such as a natural-bristle pointed brush, most preferably a #4 red sable brush. Fine steel wool, such as 0000 grade steel wool, may also be provided to remove putty from the surrounding floor area. The kit may further include an amount of polyurethane for use as a topcoat.

The present invention provides an aesthetically pleasing, repaired floor surface that is achieved quickly and without sanding. The epoxy resin used to fill in the repair has the further property of being flexible; it won't pop out when the floor flexes from people walking on it.

### BRIEF DESCRIPTION OF THE DRAWINGS

Further aspects of the invention and their advantages can be discerned in the following detailed description, in which like characters denote like parts and in which:

FIG. 1 is a schematic diagram of a wood flooring repair kit, showing preferred components of the kit;

FIG. 2 is a flow diagram showing a method for repairing a scratch or gouge in a wood floor according to the kit of FIG. 1;

FIG. 3A is a schematic isometric view showing a wood floor having a scratch or gouge in the upper surface, prior to repair with the kit of FIG. 1;

FIG. 3B is the same view shown in FIG. 3A, but after the scratch was filled according to the method of FIG. 2;

FIG. 4A is a highly magnified schematic sectional view taken substantially along line 4A-4A of FIG. 3A;

FIG. 4B is a view taken along the same section as FIG. 4A, after debris from the scratch has been removed and any raised edges have been depressed to below the general floor surface;

FIG. 4C is a highly magnified schematic sectional view taken substantially along line 4C-4C of FIG. 3B;

FIG. 5 is a highly magnified and schematic longitudinal sectional view showing a wood floor scratch being repaired with the aid of a flexible plastic card;

FIG. 6A is a magnified photograph showing a scratch or gouge in a wood surface after the scratch was filled and subsequent to the card of the kit having been drawn across the surface at a thirty degree angle;

FIG. 6B is a magnified photograph showing a scratch or gouge in a wood surface after the scratch was filled and subsequent to the card of the kit having been drawn across the surface at a forty degree angle;

FIG. 6C is a photograph showing a scratch or gouge in a wood surface after the scratch was filled and subsequent to the card of the kit having been drawn across the surface at a forty-five degree angle;

FIG. 6D is a photograph showing a scratch or gouge in a wood surface after the scratch was filled and subsequent to the card of the kit having been drawn across the surface at a fifty degree angle;

FIG. 6E is a photograph showing a scratch or gouge in a wood surface after the scratch was filled and subsequent to the card of the kit having been drawn across the surface at a sixty degree angle; and

FIG. 6F is a photograph showing a scratch or gouge in a wood surface after the scratch was filled and subsequent to the card of the kit having been drawn across the surface at a ninety degree angle.

### DETAILED DESCRIPTION

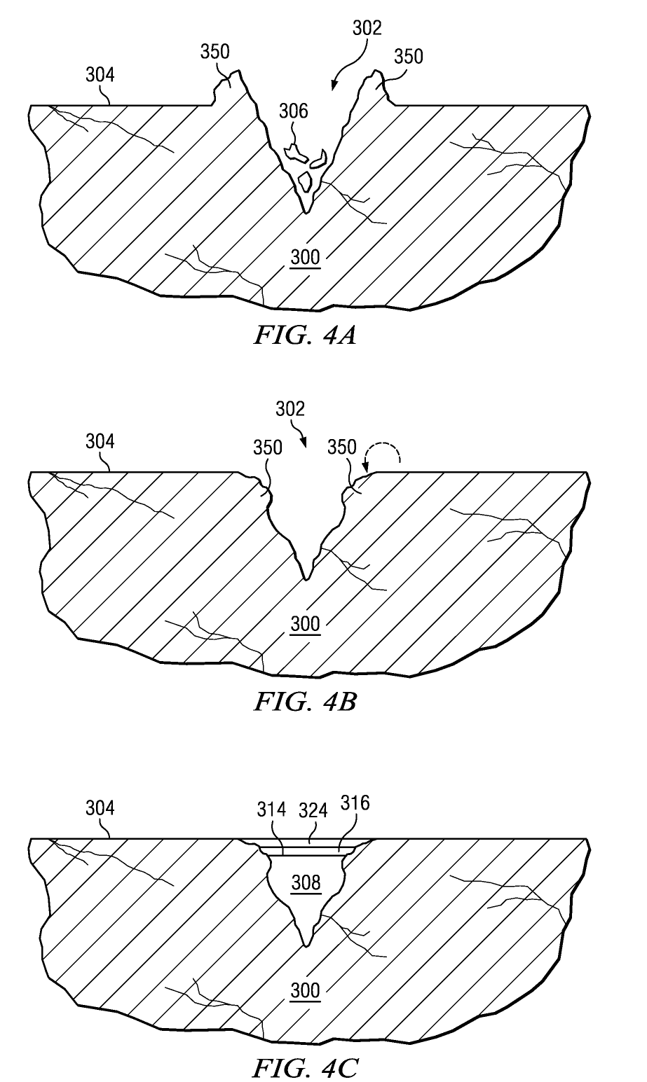

The invention generally relates to the field of repairing wood or wood laminate flooring but may be used on other wood surfaces as well. As used herein, the terms “scratch” and “gouge” are used interchangeably within the description and the claims and are generally used to describe any imperfection in the flooring that creates a depression, or low point, in the floor. Usually, the same forces which create the scratch in the floor create a raised ridge next to it (see FIG. 4A); at least some of the wood in the scratch gets displaced rather than completely removed. A successful repair, then, must fill in the valley created by the scratch, and also address the hill(s) on one or both sides of it.

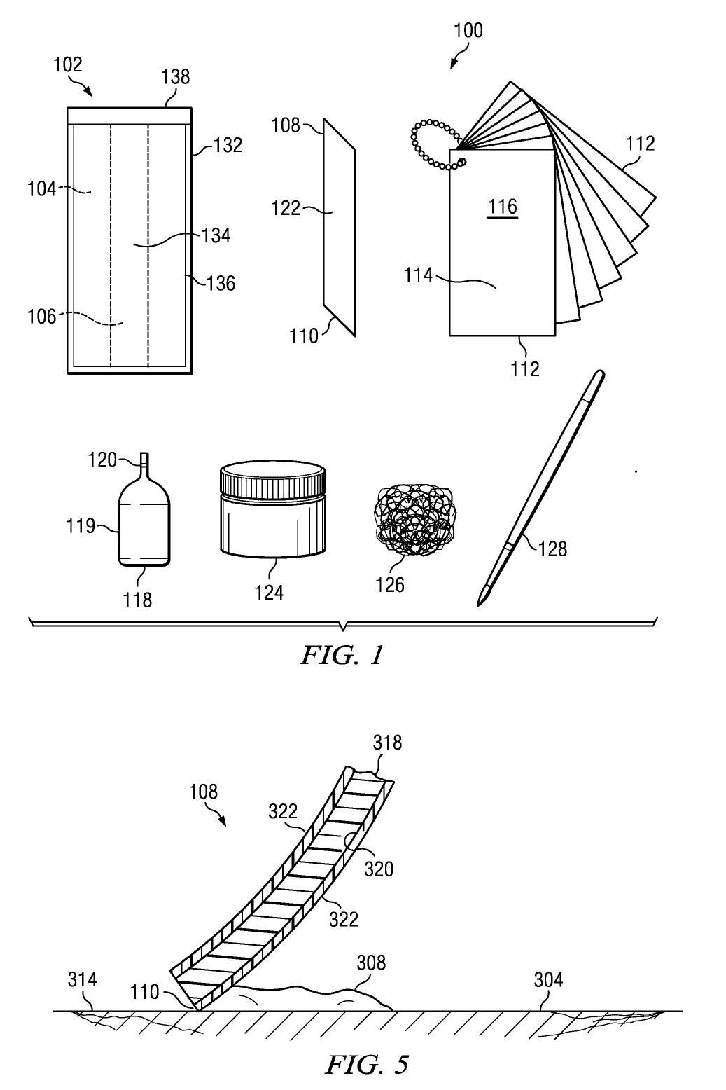

FIG. 1 illustrates the components of a kit 100 for use in carrying out the invention. Minimally, the kit 100 should include a two-part epoxy putty 102, a flexible card 108 with a substantially straight and flat edge 110, a set of color cards 112, and an activator solution 118 used as a solvent and vehicle for the lacquer on the cards 112. The kit 100 preferably further includes a brush 128, used for applying the dissolved lacquer, some fine steel wool 126 for cleaning up residual putty, and a container 124 of urethane solution which is useful to form a polyurethane top coat on the repaired scratch.

A first part 104 of the two-part epoxy putty 102 has an epoxy resin, such as bisphenol A epoxy resin, and a filler that is selected from the group consisting of alkali silicates, alkaline earth silicates, silicas, borosilicates, and mixtures of the foregoing. The resin generally makes up between about ten weight percent and about thirty weight percent of the first part 104 of the putty 102. The filler or fillers constitute between about sixty percent and about ninety percent by weight of the first part 104 of the putty 102. Alkali silicates, alkaline earth silicates, silicas, and borosilicates are preferred because as embedded in the cured resin they effectively approximate the density of wood and because they provide the necessary wear surface and durability that is required for a successful wood floor repair compound. Calcium and magnesium silicate hydrates are representative acceptable alkali silicates. Epoxy putties having borosilicate particles are preferred. A bisphenol A epoxy resin, as cured, also will be flexible enough that the repair won't “pop out” of the repaired scratch when the floor flexes under loading.

A second part 106 of the putty 102 has a hardener that, when combined with the first part 104, causes the mixture to harden. Usually, the amount of second part 106, when compared to that of the first part 104, is relatively small, usually between about one percent to about five percent by weight of the putty 102. The ranges described above are merely illustrative and should not be construed as limiting, since the composition of the first and second parts 104, 106 can vary widely. Preferred hardeners include 2,4,6-tri(dimethylaminomethyl)phenol and other amine accelerators.

Preferably, the two-part epoxy putty 102 is packaged in a tube 132. The second part 106 having the hardener can be formed as a cylinder 134 of material that is surrounded by the first part 104. The first part, which surrounds the second part, is wrapped in an air-tight material 136, such as cellophane, and is housed in the outer tube 132, which is sealed with a lid 138. This packaging arrangement allows the first and second parts 104, 106 to be used in predefined amounts by cutting the putty into sections. However, the packaging can take other forms and the first and second parts 104, 106 can even be in separate containers, so long as they remain separate until they are mixed.

The card 108 provided in the kit 100 must have certain characteristics of elasticity, moderate softness and slipperiness to be effectively used in the invention. Card 108 must be sufficiently soft so as not to further scratch the wood or floor surface 304; many plastics will meet this criterion but most metals, ceramics and even some wood constructions won't. As an example, a metal card or object having a metal edge is hard enough to damage the surface 304 of the floor 300. The card 108 must also be sufficiently rigid to adequately remove the excess portion (described in more detail below) of the putty, yet be flexible or elastic enough to impose a degree of spring force on the scratch being repaired. Card 108 should be robust enough that it won't fracture from the manual forces which will be placed on it. In preferred embodiments, the card 108 has at least a core 318 made from a plastic such as polyvinyl chloride acetate (PVCA).

Referring to FIG. 5, the card 108 can have polymer laminations 322 on one or both sides 320 of the core 318. The polymer lamination 322 has surface properties such that the putty 308 does not readily adhere to the card and can easily be removed. Thus, the coefficient of friction of the laminations 322 with respect to the mixed but uncured putty should be small, i.e., it is slippery. For instance, the mixed putty 308 would readily adhere to a card made of wood just as it does to the wood surface of the scratch 302. The coefficient of friction of laminations 322 should be sufficiently low that when an edge thereof is drawn across the filled-in, uncured putty, putty won't pull out of the repaired scratch. Suitable materials for lamination 322 include polyvinyl chloride acetate and clear plastic films. Since the polymer lamination 322 forms the outer surface of the card 108 and, therefore, contacts the surface 304, the polymer lamination 322 is preferably softer than wood flooring. The overall thickness of the card 108 can be between 0.033 inches and 0.075 inches, depending on the other properties of the material such as its relative flexibility or rigidity. More preferably, the thickness is approximately 0.055 inches.

Returning to FIG. 1, the activator solution 118 is conveniently packaged in a bottle and contains various solvents that are used to put into solution and/or suspend the solids making up the pigmented lacquer 116 on the color cards 112. A variety of common industrial solvents may be used, but combinations of acetone, isobutyl acetate, xylene, proprionates, isopropyl alcohol, and ethylbenzene are preferred. More preferably, the activator solution 118 is made up of the components in the approximate ranges listed in Table 1 below.

TABLE 1

| | | |
|---|---|---|
| Acetone | 50-60 | wt. percent |
| Isobutyl acetate | 15-25 | wt. percent |
| Xylene | 5-10 | wt. percent |
| Ethyl 3-Ethoxyproprionate | 5-10 | wt. percent |
| Isopropyl alcohol | 2-5 | wt. percent |
| Ethylbenzene | 1 | wt. percent |
| Nitrocellulose lacquer | 5-7 | wt. percent |

The activator solution 118 should come in a container 119, such as a plastic squeeze bottle made of high density polyethylene (HDPE), that has some sort of flow restrictor 120 in it; the user only applies a few drops of solution to a selected card 112. This can be arranged by having the solution 118 serially pass through multiple small apertures, or otherwise.

Pigmented lacquer 116 is deposited as a film onto a surface 114 of the color card 112. Lacquer 116 from a selected card 112 is used to alter the color of the putty mass 308 that remains in the scratch or gouge 302 (described in more detail below). The lacquer 116 itself is a durable, yet flexible, lacquer that is capable of adhering to most materials, including metal, wood, laminate, and leather. Table 2 shows the approximate ranges for the preferred components making up the lacquer.

TABLE 2

| | | |
|---|---|---|
| 2-propoxythanol | 17-35 | wt. percent |
| 2-butoxyethanol | 9-31 | wt. percent |
| Resin | 14-28 | wt. percent |
| Isopropanol | 3-8 | wt. percent |
| Toluene | 0-4 | wt. percent |
| Titanium dioxide | 0-40 | wt. percent |
| Pigments | 0-12 | wt. percent |
| Silicon dioxide | 0-6 | wt. percent |

It has been found that brush 128 ideally is a pointed #4 red sable brush. Steel wool 126 can be of 0000 fineness.

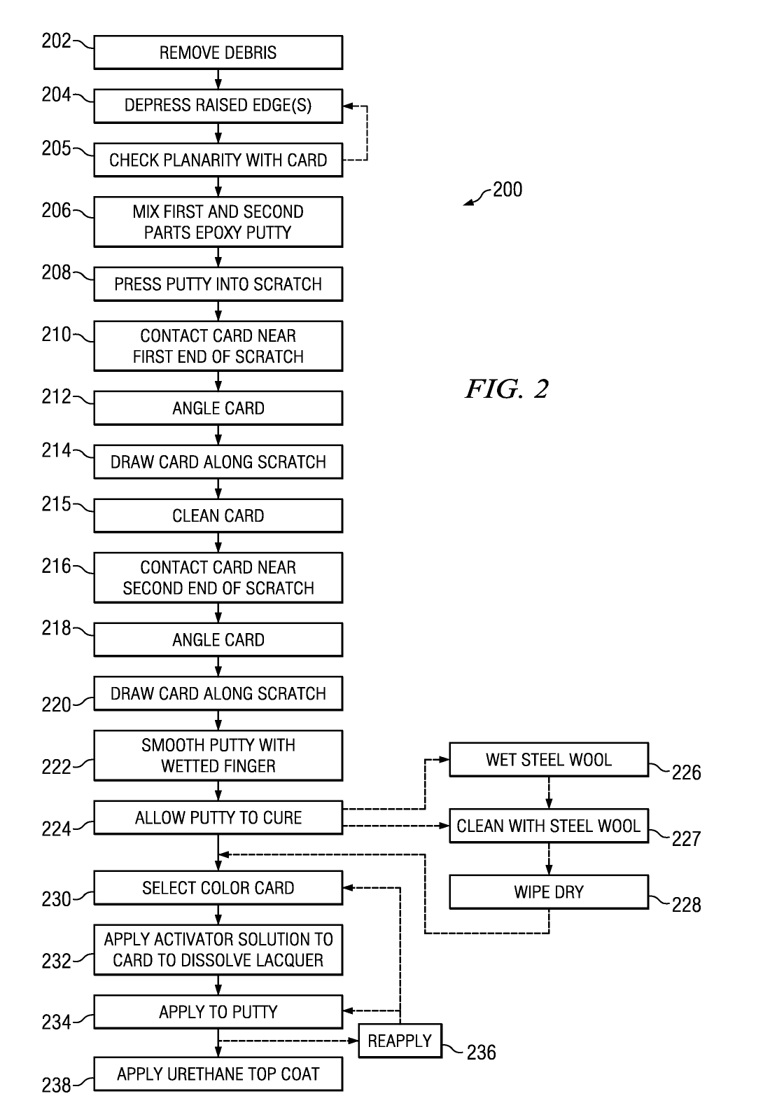

In practice, the kit 100 is used according to the method, indicated generally at 200, shown in FIG. 2. As a first step (202), any debris 306 (FIG. 4A), such as dirt or loose wood fibers, is removed from the scratch or gouge 302. The user further prepares the scratch 302 by depressing (204) any raised edges 350 which were made at the same time as the scratch. The raised edges 350 are pressed downward into the scratch “valley”, to a level at or preferably below the original floor surface 304; see FIG. 4B. This may be done by rolling or scraping a hard object along each edge of the scratch 302. For example, the user can use a hard ball to roll down both scratch edges 350 at once, or use a hard cylindrical surface as might appear on a cylindrical bar, or which can form the bottom of one of containers. The bottom of the container 124 of urethane, as provided in the kit 100, is well suited for this purpose. This depressing, rolling or scraping step takes the place of sanding the scratch down to the original floor surface, which if it were done would greatly expand the surface area needing repair and refinishing and making the repair much more visible once done.

To determine whether the raised edge(s) haven been removed, the user should check (205) the planarity of the floor surface 304 surrounding the scratch with card 108. Steps 204 and 205 can be iterated until the desired flat condition of the floor surface is achieved.

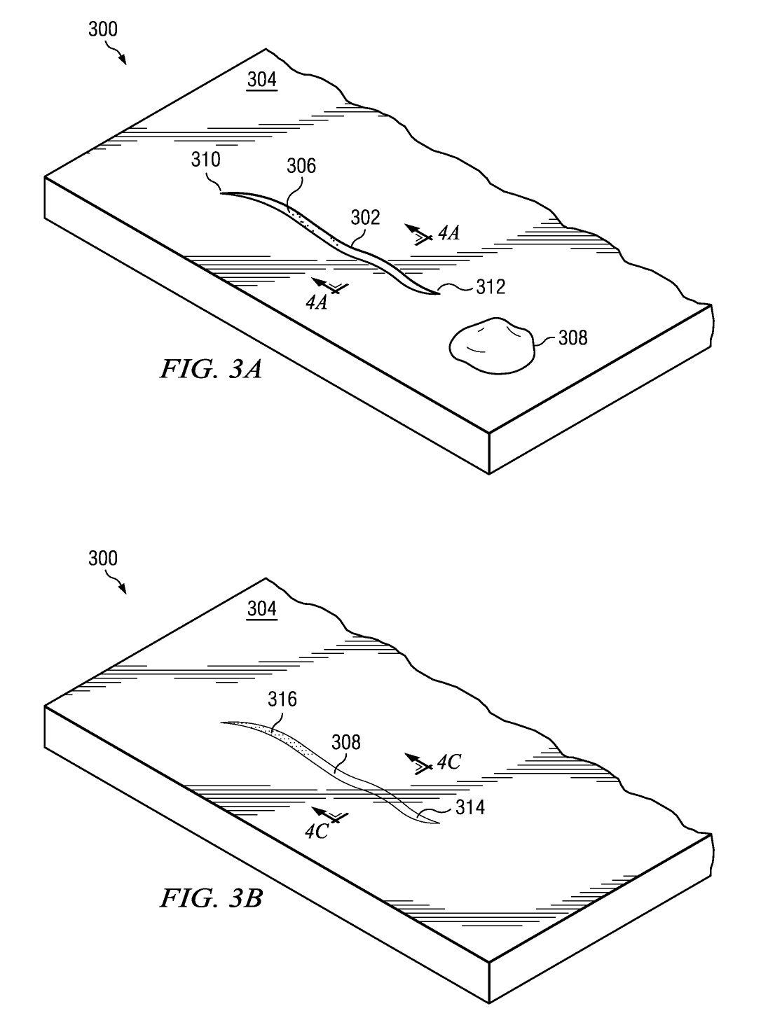

Next, the user mixes (206) a predetermined amount of the first epoxy part 104 with a predetermined amount of the second hardener part 106 to form a putty mass 308 (FIGS. 3A and 5) whose total volume exceeds that of the scratch or gouge 302. Preferably, the putty mass 308 is mixed for approximately one minute and rolled into a ball.

Once the putty 308 has been mixed, the user fills the scratch or gouge 302 by pressing (208) a portion of the putty mass 308 (the ball of putty) into the scratch or gouge 302. Referring to FIGS. 3A and 5, the user then contacts (210) the edge 110 of the card 108 to the surface 304 of the floor 300 at a point near a first end 310 of the gouge or scratch 302, angling (212) a downward surface 122 of the card 108 toward the scratch or gouge 302 at an angle of between approximately a forty and fifty degrees relative to the surface 304, with sufficient force that the card 108 will flex (FIG. 3C), imposing a steady spring force on the work. Keeping on this pressure, the user draws (214), in a single continuous motion, the card 108 from the first end 310 of the scratch 302 to a second end 312 of the scratch 302. More preferably, the angle should be approximately forty-five degrees (45°). This angle is taken at the junction of edge 110 and the surface 304; the flexing of the card 108 is exaggerated in FIG. 5 and will not appreciably affect this angle.

The user cleans (215) the removed putty off of the card surface. This is important because the putty will stick to itself and will tend to pull putty out of the repair in the subsequent reverse stroke. The user then reverses the direction of the first filling sequence, contacting (216) the edge 110 of the card 108 to a location on the surface 304 of the floor 300 near the second end 312 of the scratch or gouge 302, angling (218) the downward surface 122 of the card 108 toward the scratch or gouge 302 at an angle of between approximately forty and fifty degrees relative to the surface 304 of the floor 300, and drawing (220), in a single continuous motion and while keeping pressure on the work, the angled card 108 along the gouge or scratch 302 from the second end 312 to the first end 310. This method removes excess putty mass 308 above the surface 304 of the floor 300, further presses the putty 308 into the gouge or scratch 302, and forms an upper surface 314 of the remaining putty mass 308.

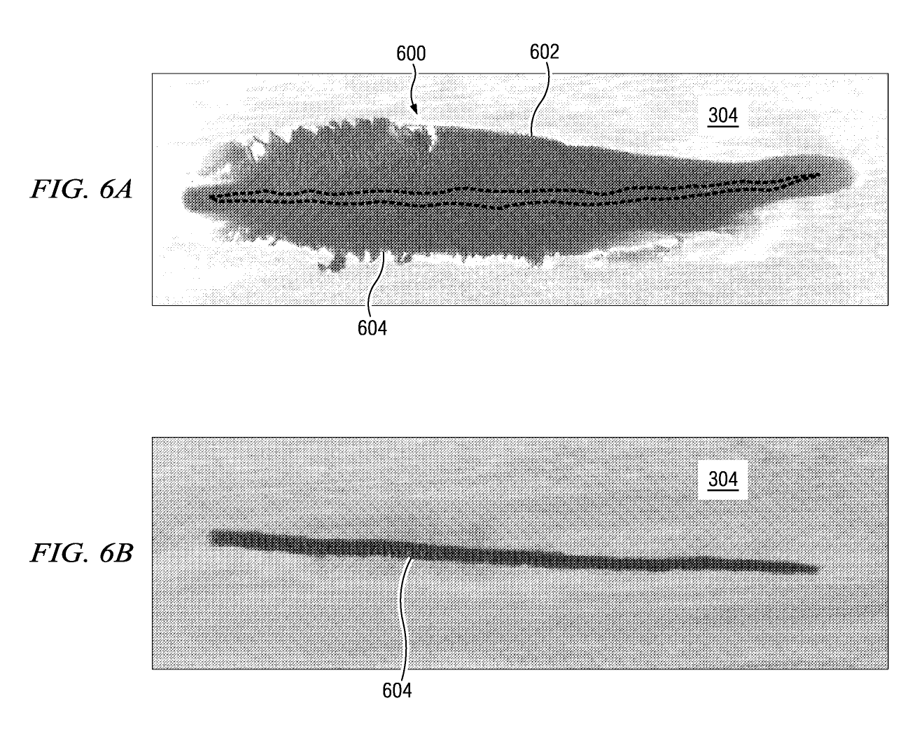

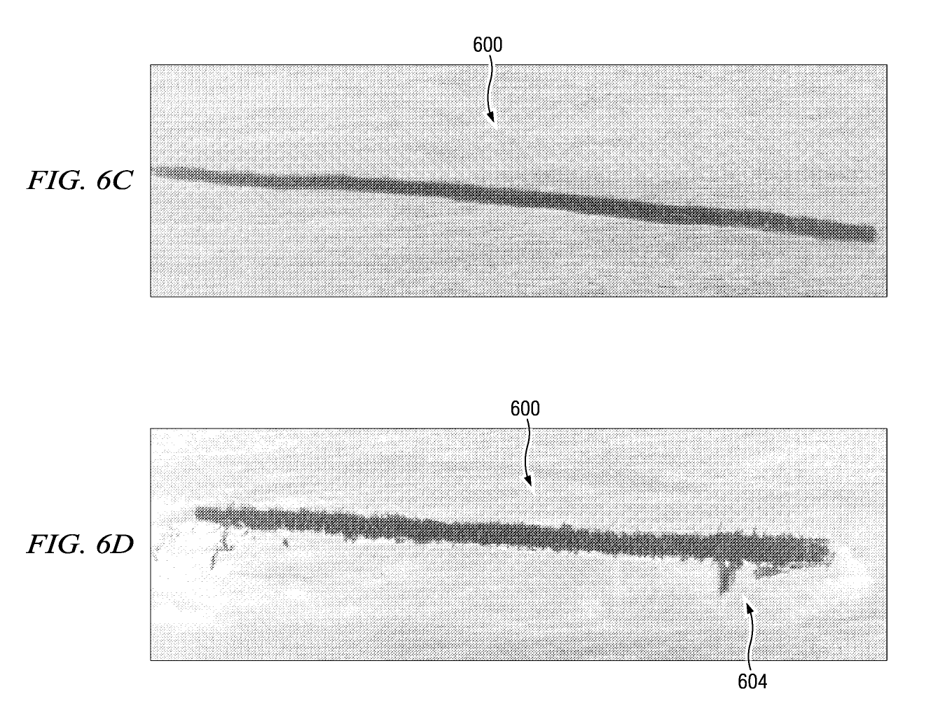

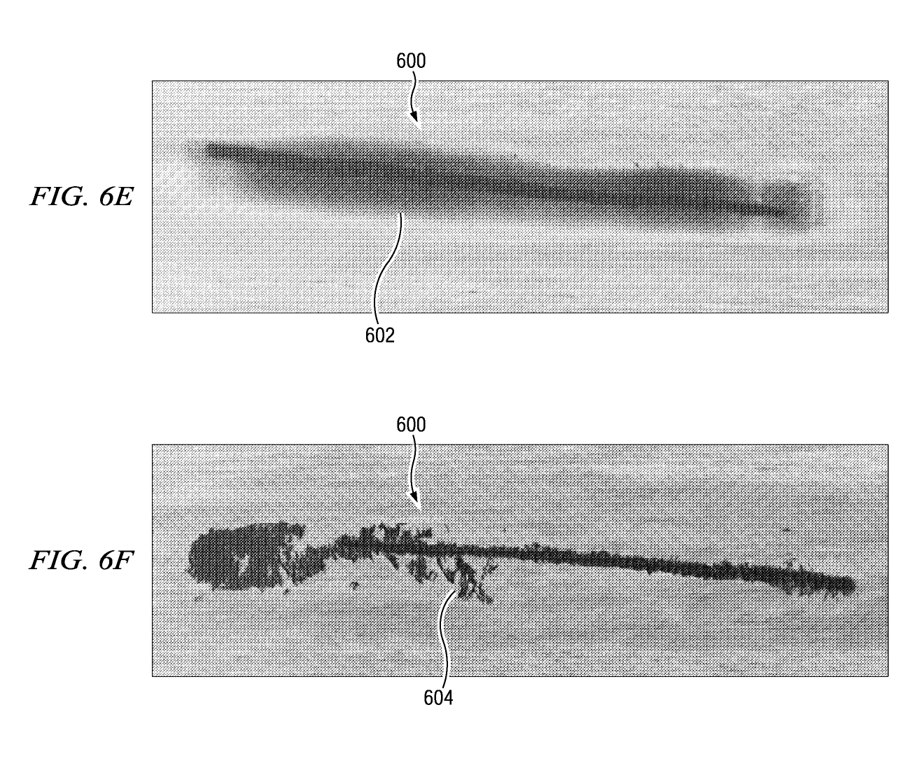

To illustrate the importance of maintaining the proper angle, FIGS. 6A-6F show the wood surface after the card 108 has been drawn (214), (220) along the repair area 600 having the scratch or gouge 302 at different angles. FIG. 6A shows that if the card 108 is angled (212), (218) at thirty degrees and drawn (214), (220) across the surface 304, it will not cleanly remove the putty mass 308. Instead, a card 108 drawn (214), (220) at thirty degrees, spreads an excess portion 602 of the putty mass 308 over an area that is adjacent to the scratch or gouge 302. This excess portion 602 is raised above the surface 304 and often has an uneven surface because the excess portion is made up of many lumps 604 of putty. In removing the excess portion 602, many users subsequently remove too much putty, thereby leaving a portion of the scratch 302 unfilled.

FIG. 6B shows a surface 304 from which the putty mass 308 has been removed by drawing (214), (220) the card 108 at a forty degree angle. The excess portion 602 has been removed and only small lumps 604 of putty remain. FIG. 6C shows that, when the card 108 is angled at forty-five degrees, the appearance of these small lumps 604 is further diminished. FIGS. 6D-6F show that as the angle of the card 108 is increased to fifty, sixty, and ninety degrees, respectively, the problems associated with the excess portion 602 of the putty mass 308 and the lumps 602 continue to be a problem. Thus, FIGS. 6B-6D show that an angle of between forty and fifty degrees is preferable. Even more preferably, an angle of approximately forty-five degrees achieves optimum results because it simultaneously presses the putty mass 308 into the scratch 302 and removes the excess putty mass 308 without pulling it out of the scratch 302.

The user may then prepare the upper surface 314 by smoothing (222) it with his or her wetted finger across the upper surface 314. Water is sufficient as a wetting agent, but saliva works even better as it tends to be more slippery. This step (222) achieves a smooth finish on the upper surface 314 and eliminates the need for sanding, which would damage the surrounding surface 304.

After allowing (224) the putty mass 308 to cure, preferably for at least one hour, the user may further prepare the surface by cleaning (227) an area around the scratch 302 with fine steel wool to remove any remaining residue. Wetting (226) the steel wool before cleaning (227) allows the user to better see the surface 304 of the wood and removes particulates, but the area must be wiped (228) dry before proceeding to the next step.

The user applies pigmentation to the putty by selecting (230) the color card 112 from the plurality of color cards 112 that best matches the color of the surface 304 of the floor 300. The user then applies (232) a few drops of the activator solution 118 to the surface 116 of the selected color card 112 to dissolve and/or be a vehicle for the pigmented lacquer 114 deposited thereon. The fluid solution of lacquer 114 and activator solution 118 are then applied (234) by brush 128 to the upper surface 314 of the now cured putty mass 308 within the scratch or gouge 302 to form a lacquer layer 316 into and on the upper surface 314. If the color match is not as close as desired, the user may alter the color of the upper surface 314 by reapplying (236) a lacquer 114 to the top surface 314. The lacquer 114 that is reapplied may come from the color card 112 originally selected or from a different color card 112.

The lacquer layer 316 is flexible, will adhere to metal, leather, wood, and laminates, and leaves a glossy finish.

Once the top surface 314 is properly coated with a lacquer layer 316, the user may choose to further protect the repair by applying (238) a topcoat 324 of urethane 124 to the upper surface lacquer layer 316. This additional layer is not strictly necessary, as lacquer layer 316 and the cured putty mass 308 are durable enough to handle high traffic areas. However, the topcoat 324 of polyurethane (after polymerization of the urethane 124 supplied in the kit 100) further increases durability.

In summary, the method of repairing a wood or laminate floor with the floor repair kit described above can be used to repair surface imperfections and extend the life of hard wood floors. Additionally, the kit can easily be used by either a professional or an amateur without risk of further damage to the floor and without sanding. While illustrated embodiments of the present invention have been described and illustrated in the appended drawings, the present invention is not limited thereto but only by the scope and spirit of the appended claims.

We claim:

1. A method of repairing a scratch in a surface of a floor faced with solid wood or wood laminate, comprising the steps of
removing debris from the scratch;
pressing down any raised edges that border the scratch to a level at or below the general surface of the wood or laminate;
providing a two-part epoxy putty in which a first part of the putty includes an epoxy resin and a filler selected from the group consisting of alkali silicates, alkaline earth silicates, silicas, borosilicates and mixtures of the foregoing and a second part including a hardener;
mixing a predetermined amount of the first part with a predetermined amount of the second part into a putty mass whose total volume exceeds that of the scratch;
pressing a portion of the putty mass into the scratch;
contacting a straight edge of a flexible card to the surface at a point near a first end of the scratch, the card selected to have a surface which substantially does not stick to the putty and to have a straight edge which is softer than the floor surface;
angling a downward surface of the card toward the scratch at an angle of between forty and fifty degrees relative to the surface;
drawing the angled card along the scratch from the first end to a second end while maintaining downward pressure on the card to remove excess putty mass and to further press the putty into the scratch;
removing any putty from the card;
contacting the edge of the card to a location on the surface near the second end of the scratch;
angling the downward surface of the card toward the scratch at an angle of between forty and fifty degrees relative to the surface;
drawing the angled card along the scratch from the second end to the first end while maintaining downward pressure on the edge of the card to fill in any remaining voids in the scratch;
allowing the putty mass in the scratch to cure;
selecting a color card from a plurality of color cards to match the color of the surface;
applying an activator solution to a surface of the color card to dissolve and/or suspend a pigmented lacquer deposited on the surface of the color card; and
applying the dissolved/suspended lacquer and activator solution to an upper surface of the putty mass within the scratch to create a lacquer layer above the upper surface of the putty mass.

2. The method of claim 1, further comprising the step of
subsequent to said step of pressing down any raised edges, drawing a flat edge of the card over the scratch to ensure that the raised edges are not higher than the surface of the floor.

3. The method of claim 1, further comprising the step of
following said step of applying the lacquer and activator solution, applying urethane to the upper surface of the lacquer layer to create a topcoat of polyurethane.

4. The method of claim 1, further comprising the step of:
prior to said step of applying the lacquer and activator solution, smoothing the upper surface of the putty mass with a wetted finger.

5. The method of claim 1, further comprising the step of:
subsequent to the step of allowing the putty mass to cure, cleaning an area around the scratch with a pad of steel wool.

6. The method of claim 5, the step of cleaning further comprising the substep of dampening the pad of steel wool.

7. The method of claim 1, further comprising the step of:
after said step of applying the dissolved/suspended lacquer, reapplying lacquer to the lacquer layer.

8. The method of claim 1, wherein the angle is approximately forty-five degrees.

9. A kit for repairing a scratch in a surface of a floor faced with solid wood or wood laminate, the kit comprising
a two-part epoxy putty including
a first part of the putty including an epoxy resin and a filler selected from the group consisting of alkali silicates, alkaline earth silicates, silicas, borosilicates and mixtures of the foregoing;
a second part having a hardener;
a flexible plastic card having a substantially straight and flat edge;
a plurality of color cards, each color card having a pigmented lacquer deposited on a surface of the color card; and
a container having therein an activator solution for dissolving the pigmented lacquer off of the surface of the color card.

10. The kit of claim 9, wherein the container of activator solution includes a flow restrictor for dispensing drops of activator solution.

11. The kit of claim 9, further comprising a pad of fine steel wool for cleaning an area around the scratch.

12. The kit of claim 9, further comprising a container having therein a urethane composition for forming a protective polyurethane top coat over a lacquer layer formed in the scratch by the lacquer and the activator solution.

13. The kit of claim 9, further comprising a red sable hairbrush for applying the pigmented lacquer and activator solution to the putty surface.

14. The kit of claim 9, wherein the flexible plastic card comprises a polyvinyl chloride acetate core having two sides and a polymer lamination on at least one side of the core.

15. The kit of claim 14, wherein the polymer lamination is made of polyvinyl chloride acetate.

16. The kit of claim 9, wherein the polymer lamination is softer than wood.
